(19) United States
(12) Patent Application Publication
(10) Pub. No.: US 2016/0252244 A1
(43) Pub. Date: Sep. 1, 2016

(54) Smoke Detector, Emergency Light and Alternate Light Source System

(71) Applicant: Marcia Lawson, Houston, TX (US)

(72) Inventor: Marcia Lawson, Houston, TX (US)

(21) Appl. No.: 14/633,266

(22) Filed: Feb. 27, 2015

(51) Int. Cl. F21V 33/00; F21V 23/04; F21S 9/02; G08B 17/10; G08B 5/38

(52) U.S. Cl. CPC F21V 33/0076; G08B 17/10; G08B 5/38; F21S 9/02; F21V 23/0442; F21V 23/0457

(57) ABSTRACT

A self-contained smoke alarm detector, emergency light and alternate light source mechanism in one unit.

### BACKGROUND OF THE INVENTION

Federal law requires that a smoke detector/alert unit be place in specific locations in all residential dwellings. This provides warning to occupants in the event that smoke is detected; however, in the event of an electrical outage, occupants of these dwellings are usually not prepared. Residents can purchase an emergency light unit separately; however, this is not typically done Generators are pricy, costly to operate and could result in fatality if not properly operated.

This unit provides a smoke detector, emergency lighting and a light source in one unit. The unit eliminates the need to purchase separate units and requires no special electrical wiring since it plugs directly into the current hardwire smoke detector setup. A smoke detector in an existing home can be easily replaced with this unit.

Current smoke detectors/alarm system radiate a loud sound when smoke is detected however a hearing impaired person may not necessarily hear the sound. This unit consists of LED lights which pulsate the sound warning is given so that a hearing impaired person will see the pulsating light and be warned of impending danger.

### SUMMARY OF THE INVENTION

Fully functional hardwire interconnected home smoke alarm with light source. Long lasting, low maintenance, and self contained.

When the electricity is on and no smoke is detected no sound will be heard and the lights not be illuminated.

In the event of an electrical outage when no power is detected and no smoke is detected the emergency lights will be illuminated. The alarm will not sound. When power is restored and detected the lights will go out. The lights can be turned on and off manually by a built in switch on the unit.

In the event that the electricity is on and smoke is detected, the alarm will sound and the lights will pulsate; when smoke is no longer detected the alarm sound will stop and the lights will be turned off.

In the event that the electricity is of and smoke is detected, the alarm will sound and the lights will pulsate; when smoke is no longer detected the alarm sound will stop. When power is restored and detected, the lights will go out. The lights can be turned on and off manually by a built in switch on the unit.

This unit can also be used as a continuous light source in the event of loss of electricity by simply changing out the battery periodically. The on/off switch can be wall mounted for easy access to turn on and off the light easily.

### BRIEF DESCRIPTION OF THE SEVERAL VIEWS OF THE DRAWING

FIG. 1 illustrates the general circuit of the unit

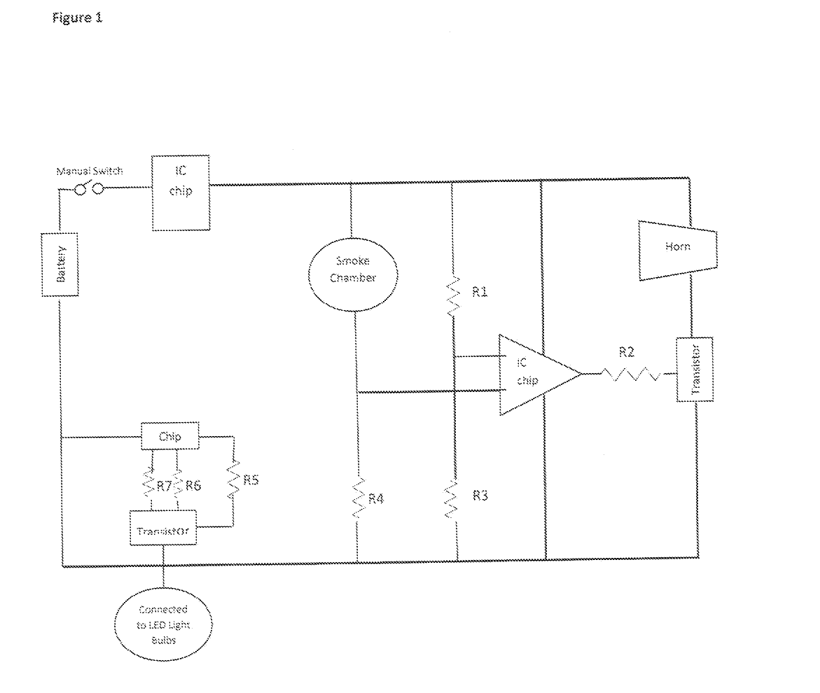

FIG. 2 shows the top view of up to eight LED light bulbs, the photoelectric eye of and up to two speakers.

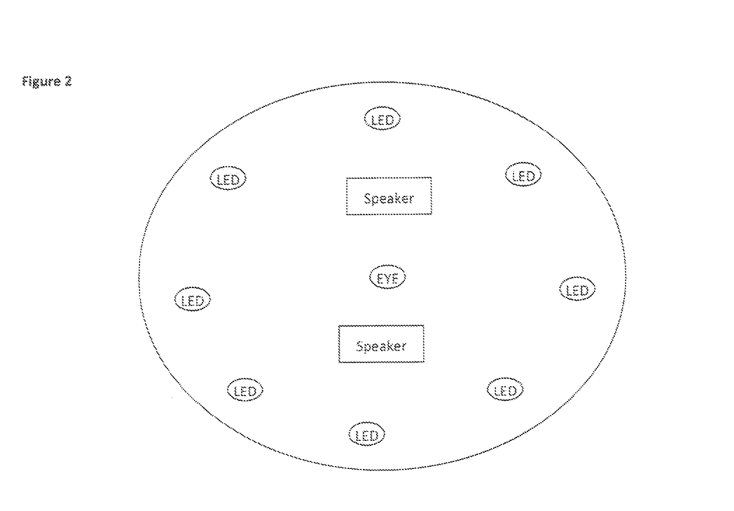

### DETAILED DESCRIPTION OF THE INVENTION

The Smoke Detector, Emergency Light & Alternate Light Source System unit is a hardwire interconnected home smoke detector with eight LED lights connected in series. The system is designed to provide light coverage of 360° degrees and provide coverage for a standard size room. A 9-volt battery will provide the current for the light source as well as function as the backup source for the operation of the smoke alarm detection.

### PATENT CITATIONS

| | Filing | Publication | | |
|---|---|---|---|---|
| Cited Patent | Date | Date | Applicant | Title |
| US 20100102960 | Oct. 24, | Apr. 29, | Altair | Integration of led lighting |
| | 2008 | 2010 | Engineering, | control with emergency |
| | | | Inc. | notification systems |
| US20140145623 | Nov. 27, | May 29, | Lon W. | Emergency Lighting |
| | 2012 | 2014 | McCullough, | System |
| | | | Luna J. | |
| | | | Anthony | |
| US D386802 | Aug. 9, | Nov. 25, | Il Kim | Combined emergency |
| | 1996 | 1997 | | lights and smoke detector |
| | | | | unit |
| U.S. Pat. No. 4,617,561 | Mar. 11, | Oct. 14, | Second | Emergency light and |
| | 1985 | 1986 | Chance | smoke alarm system |
| | | | Systems, Inc. | |
| U.S. Pat. No. 6,133,839 | Oct. 17, | Apr. 9, | Ellul | Smoke detector apparatus |
| | 2000 | 1999 | Enterprises, | with emergency escape |
| | | | Inc. | indicator |
| U.S. Pat. No. 4,199,754 | Nov. 21, | Apr. 22, | Esb | Circuit for an emergency |
| | 1977 | 1980 | Incorporated | lighting and fire detector |
| | | | | system |
| U.S. Pat. No. 4,305,069 | Dec. 8, | May 31, | Machen Robert | Personal smoke and fire |
| | 1981 | 1978 | B, Thompson | detector and warning unit |
| | | | John E | |

1) A method of alerting occupants in case of a smoke or fire emergency. If smoke is detected and electricity is on; Lights will pull ate and alarm sound. If smoke is detected and electricity is off; lights will pulsate and the alarm will sound.

2) A method of providing emergency light in case of an electrical Outage. If no smoke detected and the electricity is off; no sound will be heard and the light will come on.

3) A method of providing light in case of no electricity, if no smoke is detected and no electricity detected; the lights will be turned on and will remain on unless turned off. The battery will have to be changed periodically in order for the unit to operate as a continuous light source.
